(19) United States
(12) Patent Application Publication
(10) Pub. No.: US 2026/0361199 A1
(43) Pub. Date: Nov. 12, 2026

(54) GAPLESS ROLLING MOTOR DEVICE

(71) Applicant: Oleksandr Dobzhanskyi, Uniontown, OH (US)

(72) Inventor: Oleksandr Dobzhanskyi, Uniontown, OH (US)

(21) Appl. No.: 19/434,700

(22) Filed: Dec. 29, 2025

Related U.S. Application Data
(60) Provisional application No. 63/801,979, filed on May 8, 2025.

(51) Int. Cl. H02K 51/00; H02K 1/14; H02K 1/2753; H02K 7/08; H02K 7/116

(52) U.S. Cl. CPC H02K 51/00; H02K 1/14; H02K 1/2753; H02K 7/08; H02K 7/116; H02K 2201/06

(57) ABSTRACT

A gapless rolling motor device is provided. The device is comprised of a stator, a rotor, and a plurality of magnetic rollers positioned between the same. Each roller includes permanent magnets mounted on a shaft. A two-phase stator winding generates a rotating magnetic field that interacts with the rollers, inducing their rolling motion along the stator surface while orbiting the rotor. Magnetic coupling between rollers and rotor produces rotor rotation, functioning as an integrated magnetic planetary mechanism. Direct rolling contact without slippage is achieved by matching pole pitch among stator, rollers, and rotor. The motor operates synchronously with speed determined by stator voltage frequency. As a result, the device enables compact construction, high torque density, and improved cooling through internal airflow and optional fluid circulation, eliminating the need for external fans.

### CROSS-REFERENCE TO RELATED APPLICATION

The present application claims priority to, and the benefit of, U.S. Provisional Application No. 63/801,979, which was filed on May 8, 2025, and is incorporated herein by reference in its entirety.

### FIELD OF THE INVENTION

The present invention relates generally to the field of motors. More specifically, the present invention relates to a motor that integrates a stator, rotor, and magnetically driven rollers to produce synchronous rotor motion through direct rolling contact and magnetic coupling. The device functions as a compact, high-torque electromechanical system with improved cooling and eliminates the need for external fans or traditional gear mechanisms. Accordingly, the present disclosure makes specific reference thereto. Nonetheless, it is to be appreciated that aspects of the present invention are also equally applicable to other like applications, devices, and methods of manufacture.

### BACKGROUND

Conventional electric motors require a narrow air gap between the stator and rotor to enable electromagnetic interaction without physical contact. This air gap, while essential for non-contact operation, imposes limitations on torque transmission efficiency and spatial compactness. Efforts to reduce or eliminate the air gap have resulted in the development of alternative designs, such as wobble motors, which utilize magnetically attracted rolling metallic elements to approximate direct contact. However, these configurations often suffer from low power density, complex torque transmission mechanisms, and increased manufacturing costs. Moreover, traditional motor systems that integrate mechanical gearboxes typically follow a sequential assembly of stator-driven rotors mechanically coupled to external gear trains. This results in additional weight and spatial demands, as well as system complexity, and does not leverage the advantages of integrated contact-based torque transfer. A significant limitation of existing designs lies in their inability to combine the principles of planetary gearing with electromagnetic drive systems in a compact and efficient manner. Furthermore, the reliance on bearings, dedicated cooling systems, and conventional torque transmission structures hinders the development of simplified and high-performance solutions. To date, no known configuration has successfully merged rolling magnetic elements with synchronous motor operation in a manner that achieves direct drive, torque multiplication, and internal cooling within a unified electromechanical framework.

Therefore, there exists a long-felt need in the art for a gapless rolling motor device that eliminates or substantially reduces the air gap between electromagnetic components to improve torque transmission. There also exists a long-felt need in the art for a gapless rolling motor device that integrates planetary gearing principles with electromagnetic drive systems to reduce complexity and enhance compactness. Moreover, there exists a long-felt need in the art for a gapless rolling motor device that enables internal cooling and bearing-free operation through the use of magnetically retained rolling elements.

The subject matter disclosed and claimed herein, in one embodiment thereof, comprises a gapless rolling motor device. The device is comprised of a stator assembly, a rotor assembly, and a plurality of magnetically active rollers arranged between the stator and rotor. The stator comprises a laminated core, two-phase stator windings, insulation, and encapsulation configured to generate a rotating magnetic field. Each roller comprises permanent magnets affixed to a roller shaft and encapsulated within non-magnetic material, enabling synchronized rolling along the stator surface while orbiting the rotor. The rotor comprises a core with surface-mounted or embedded magnets and is magnetically coupled to the rollers, resulting in torque transfer through synchronous magnetic interaction. The configuration of the pole pitches across the stator, rollers, and rotor is selected to ensure direct rolling contact without slippage, thereby enabling synchronous motor operation with rotor speed determined by input voltage frequency. Cooling is facilitated through internal airflow enabled by the spacing between rollers and the rotating roller ring, and in some embodiments, fluid circulation may be incorporated. Retaining rings and optional mechanical planetary gear configurations may be integrated to maintain roller positioning and enable alternative torque transfer methods. In bearingless embodiments, the rollers function analogously to rolling elements in conventional bearings, and the system may be skewed or sectioned to reduce cogging forces and acoustic noise.

In this manner, the gapless rolling motor device of the present invention accomplishes all the foregoing objectives and provides an improved motor that replaces the conventional air gap with rolling magnetic contact, thereby enhancing torque density and mechanical efficiency. The integration of planetary gear principles directly within the electromagnetic structure further reduces system complexity and supports compact construction. The use of rolling magnetic elements between the stator and rotor eliminates the need for separate bearings, while enabling internal airflow and optional fluid circulation for thermal management. These combined features address the deficiencies of prior motor designs and provide a scalable platform suitable for diverse applications in robotics, transportation, automation, and electromechanical actuation where compact, high-torque, and efficient motor systems are required.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a gapless rolling motor device. The device is an electric motor comprising a stator assembly, rotor assembly, and multiple magnetic rollers arranged in a roller ring. The stator includes a laminated core, windings, insulation, non-magnetic encapsulation, and stator teeth. The rotor includes permanent magnets, a rotor core, a shaft, and non-magnetic encapsulation. Each roller includes permanent magnets, a shaft, and optional encapsulation.

Rolling motion is induced by a traveling magnetic field generated by a two-phase stator winding. Magnetic alignment between the rollers, stator teeth, and rotor magnets ensures non-slipping operation. Torque is transmitted to the rotor through magnetic or mechanical coupling. In magnetic configurations, the rollers rotate in one direction, causing the rotor to rotate oppositely.

The device may operate with or without ball bearings. In bearing-free operation, rollers roll on non-magnetic surfaces, and magnetic forces maintain alignment. Airflow between rollers enables internal cooling and allows operation as a fluid pump. The device supports both inner and outer rotor configurations and can be adapted for single or multi-phase systems, axial or transverse flux machines, and linear actuators.

A planetary mechanism secures the rollers at equal spacing using retaining rings and optional brackets. The mechanism can be coupled to the rotor shaft for low-speed applications, eliminating the need for rotor magnets. Mechanical torque transmission using planetary gears is also supported, allowing greater design flexibility and eliminating pitch-matching requirements. Cogging torque is further reduced through dual offset stator sections or skewed magnetic components.

The invention further includes a method of operation wherein a stator generates a traveling magnetic field that induces roller motion between the stator and rotor. The rollers magnetically drive the rotor in the opposite direction, with alignment maintained by matching pole and tooth pitches. Rotor speed is further governed by supply frequency. Cooling fluid may also be circulated internally for heat dissipation. Rollers are retained and aligned by a planetary mechanism, which may also serve as the torque transmission path in mechanical coupling configurations, eliminating the need for ball bearings.

Accordingly, the gapless rolling motor device of the present invention is particularly advantageous as it provides an improved motor that replaces the conventional air gap with rolling magnetic contact, thereby enhancing torque density and mechanical efficiency. The integration of planetary gear principles directly within the electromagnetic structure further reduces system complexity and supports compact construction. The use of rolling magnetic elements between the stator and rotor eliminates the need for separate bearings, while enabling internal airflow and optional fluid circulation for thermal management. These combined features overcome the limitations of existing motor designs and provide a scalable platform suitable for diverse applications in robotics, transportation, automation, and electromechanical actuation where compact, high-torque, and efficient motor systems are required.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a front, partially sectional view of one potential embodiment of a gapless rolling motor device of the present invention in accordance with the disclosed architecture;

FIG. 1B illustrates a side view of one potential embodiment of a gapless rolling motor device of the present invention in accordance with the disclosed architecture;

FIG. 2A illustrates a partially sectional view of a rotor core integrated with a rotor shaft of one potential embodiment of a gapless rolling motor device of the present invention in accordance with the disclosed architecture;

FIG. 2B illustrates a partially sectional view of surface-mounted permanent magnets attached to a rotor core of one potential embodiment of a gapless rolling motor device of the present invention in accordance with the disclosed architecture;

FIG. 3A illustrates a side view of the roller shaft of one potential embodiment of a gapless rolling motor device of the present invention with surface-mounted permanent magnets in accordance with the disclosed architecture;

FIG. 3B illustrates a front view of a roller of one potential embodiment of a gapless rolling motor device of the present invention in accordance with the disclosed architecture;

FIG. 4 illustrates a perspective view of one potential embodiment of a gapless rolling motor device of the present invention in an outer rotor configuration in accordance with the disclosed architecture;

FIG. 5 illustrates a perspective view of one potential embodiment of a gapless rolling motor device of the present invention while fully assembled and wherein an integrated planetary mechanism is embedded within the stator in accordance with the disclosed architecture;

FIG. 6 illustrates a partially exploded view of one potential embodiment of a gapless rolling motor device of the present invention wherein an integrated planetary mechanism is separated from the stator in accordance with the disclosed architecture;

FIG. 7 illustrates an exploded perspective view of one potential embodiment of a gapless rolling motor device of the present invention in accordance with the disclosed architecture;

FIG. 8A illustrates a front view of a mechanical gear assembly of one potential embodiment of a gapless rolling motor device of the present invention in accordance with the disclosed architecture;

FIG. 8B illustrates a perspective exploded view of magnetic rollers and a stator assembly of one potential embodiment of a gapless rolling motor device of the present invention in accordance with the disclosed architecture;

FIG. 9 illustrates a perspective view of a ring of magnetic rollers disposed around a rotor of one potential embodiment of a gapless rolling motor device of the present invention in accordance with the disclosed architecture;

FIG. 10 illustrates a perspective view of a stator core of one potential embodiment of a gapless rolling motor device of the present invention wherein the stator core has a skew corresponding to a skew of the ring of magnetic rollers in accordance with the disclosed architecture;

FIG. 11 illustrates a perspective view of a stator winding of one potential embodiment of a gapless rolling motor device of the present invention wherein the stator winding has a skew corresponding to a skew of the ring of magnetic rollers and the skew of the stator core in accordance with the disclosed architecture;

FIG. 12 illustrates a schematic circuit diagram of one potential embodiment of a gapless rolling motor device of the present invention in accordance with the disclosed architecture; and

FIG. 13 illustrates a flowchart of a method of using one potential embodiment of a gapless rolling motor device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a gapless rolling motor device that eliminates or substantially reduces the air gap between electromagnetic components to improve torque transmission. There also exists a long-felt need in the art for a gapless rolling motor device that integrates planetary gearing principles with electromagnetic drive systems to reduce complexity and enhance compactness. Moreover, there exists a long-felt need in the art for a gapless rolling motor device that enables internal cooling and bearing-free operation through the use of magnetically retained rolling elements.

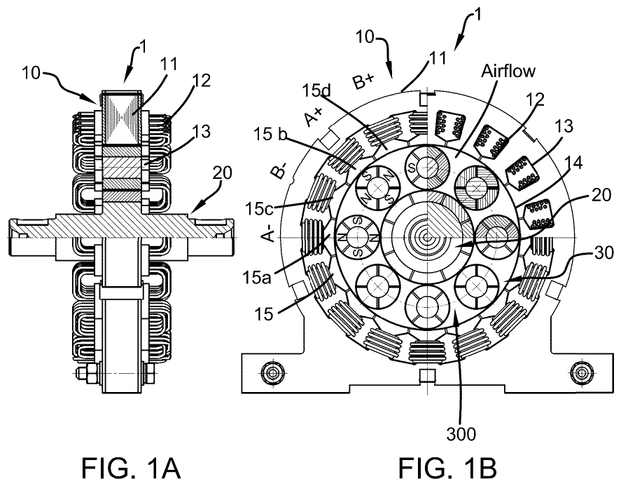

Referring initially to the drawings, FIG. 1A illustrates a front, partially sectional view of one potential embodiment of a gapless rolling motor device 1 of the present invention in accordance with the disclosed architecture. An example of the Gapless Rolling Motor (GRM), hereinafter referred to as “the device,” is illustrated in FIG. 1A and FIG. 1B. The device 1 comprises a stator assembly 10, a rotor assembly 20, and a plurality of magnetic rollers 30 combined in a roller ring 300.

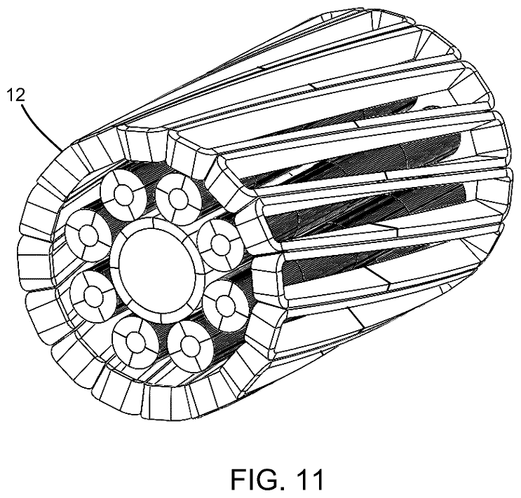

The stator assembly 10 includes a laminated steel core 11, stator windings 12 (as seen in FIG. 11), stator insulation 13, stator non-magnetic encapsulation 14, and a plurality of stator teeth 15. The winding 12 of the device 1 can be either concentrated or distributed, depending on the desired performance.

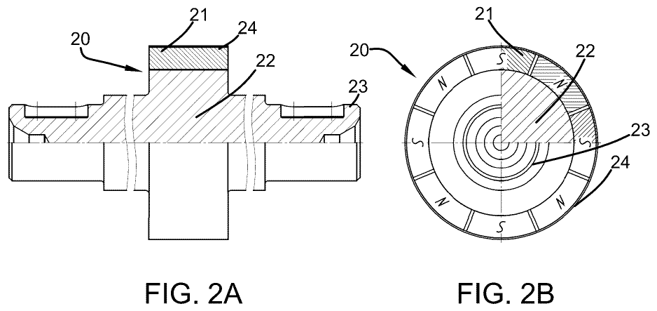

The rotor assembly 20, as seen in FIG. 2A and FIG. 2B, is comprised of a plurality of permanent magnets 21, a rotor core 22, a rotor shaft 23, and a non-magnetic rotor encapsulation 24. In this embodiment, the magnets 21 are surface-mounted on the solid rotor core 22, which is combined with the shaft 23. Alternatively, the rotor core 22 can be made of laminated steel and may be mounted on the rotor shaft 23. In this configuration, the magnets 21 can either be surface-mounted on the laminated rotor core 22 or embedded within the core 22.

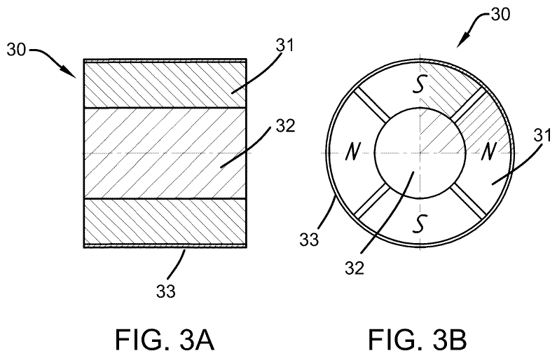

FIG. 3A and FIG. 3B illustrates the magnetic roller assembly 30, wherein each roller assembly 30 comprises a plurality of permanent magnets 31, a roller shaft 32, and a non-magnetic encapsulation 33. This embodiment may also have a laminated roller core that can be fixed to the roller shaft 32, wherein the magnets 31 in this roller core can either be surface-mounted or internally embedded within the core.

The stator encapsulation 14, roller encapsulation 24, and rotor encapsulations 33 may only be present in embodiments when the device 1 is designed to operate without ball bearings. In this embodiment, the rollers 30, being encapsulated with non-magnetic encapsulation 33, are configured to roll on the stator encapsulation 14 and rotor encapsulation 24 in a manner analogous to ball bearings rolling between moving and stationary rings of conventional bearings. Accordingly, the device 1 can operate without ball bearings, as the rollers 30 perform this function. Axial alignment of the rollers 30 and the rotor 20 is maintained by magnetic attraction between the rollers 30 and the rotor 20, as well as by the electromagnetic field of the stator 10. This configuration enables bearing-free operation, which is not achievable in conventional electric motors.

At the same time, the device 1 can incorporate ball or friction bearings and maintain a small air gap between the rotor 20 and rollers 30, and stator 10 and rollers 30. In this case, the encapsulations 14, 24, and 33 can be removed from the motor.

As shown in FIG. 1, the device 1 allows airflow through the interior of the device 1, which is a capability not possible in conventional electric motors, where the stator 10 and rotor 20 are separated by a narrow air gap. In the device 1, the spaces between the magnetic rollers 30 facilitate efficient internal cooling. Additionally, as the roller ring 300 rotates around the rotor 20, the roller ring 300 generates air turbulence inside the device 1 that enhances heat dissipation without requiring an external cooling fan. This configuration also makes it possible to circulate fluid through the device 1, enabling the device 1 to operate as a fluid pump when needed.

The two-phase winding 12 of the stator 10 produces a traveling magnetic field that interacts with the magnetic poles of the rollers 30, thereby inducing rolling motion. The rollers 30 maintain non-slipping engagement with respect to the stator 10 and rotor 20 poles. This is achieved because during roller 30 rotation, the magnetic poles of each roller 30 are configured to align with the stator teeth 15 and the rotor magnets 21, such that the roller 30 pole pitch length (i.e., the length of the outer circumference of the roller 30 divided by the number of roller 30 poles) corresponds to the stator tooth 15 pitch length (i.e., the length of the inner circumference of the stator 10 divided by the number of stator teeth 15), and the rotor 20 pole pitch length (i.e., the length of the outer circumference of the rotor 20 divided by the number of rotor 20 poles). The total number of rollers 30 determines the number of poles within the device 1.

FIG. 1 illustrates the position of the rollers 30 within the stator 10 at a specific time instant. In the depicted position, Phase A is de-energized because the rollers 30 have already aligned with the Phase A teeth 15a and 15b. Phase B is then energized, as indicated by the polarity signs in the FIG. 1B. The teeth 15c of the B− B-phase attract the south(S) pole and repel the north (N) pole of the roller, while the B+ teeth 15d repel the S pole and attract the N pole. As a result, the rollers 30 advance along the surface of the stator 10 in a clockwise direction, and Phase A is subsequently energized to sustain this motion. When the rollers 30 align with the Phase B teeth 15c and 15d, Phase B is de-energized while Phase A remains energized, following the same operating principle. This sequence can be controlled by supplying the device 1 phases with two sinusoidal voltages offset by ninety electrical degrees. Through this process, the rollers 30 rotate about their own axes, and the roller ring 300 rotates about the rotor 20 axis. Connected with rotor 20 by magnetic flux, the rollers 30 drive the rotor 20 in the opposite direction of the roller 30 rotation. However, the roller ring 300 rotates around the stator 10 in the same direction as the rotor 20. Since in the presented embodiment each roller 30 includes four magnetic poles, and the stator 10 comprises sixteen teeth 15, a single revolution of the roller 30 results in the traversal of four stator 10 poles, corresponding to one-quarter of the stator 10 circumference.

Consequently, the rotational speed of the roller ring 300, denoted as nring, is one-quarter of the rotational speed of an individual roller 30, denoted as:

$${n}_{r i n g} = - \frac{1}{4} {n}_{r o l l e r} \qquad ( 1 )$$

In the presented embodiment, the radius of the rotor 20 is twice the roller 30 radius, resulting in the rotor speed n_“rotor” being one-half of the roller 30 speed. Additionally, the rotor 20 undergoes rotation induced by the roller ring 300 movement; therefore, these two components of motion are combined to determine the total rotor 20 speed.

$${n}_{rotor} = - {n}_{r i n g} - \frac{1}{2} {n}_{r o l l e r} \qquad ( 2 )$$

Substituting (1) into (2) gives:

$${n}_{rotor} = - \frac{1}{4} {n}_{r o l l e r} - \frac{1}{2} {n}_{r o l l e r} = - \frac{3}{4} {n}_{r o l l e r} \qquad ( 3 )$$

Rewriting (3) for nᵣₒₗₗₑᵣ:

$${n}_{r o l l e r} = - \frac{4}{3} {n}_{rotor} \qquad ( 4 )$$

Substituting (4) in (1) we obtain:

$${n}_{r i n g} = \frac{1}{3} {n}_{rotor} \qquad ( 5 )$$

The speed of the rotor is found as:

$${n}_{r o l l e r} = \frac{120 f}{2} \qquad ( 6 )$$

The voltage frequency f is found as:

$$f = \frac{( {n}_{r o l l e r} )}{60} \qquad ( 7 )$$

Substituting (4) into 7 gives:

$$f = \frac{1}{45} {n}_{rotor} \qquad ( 8 )$$

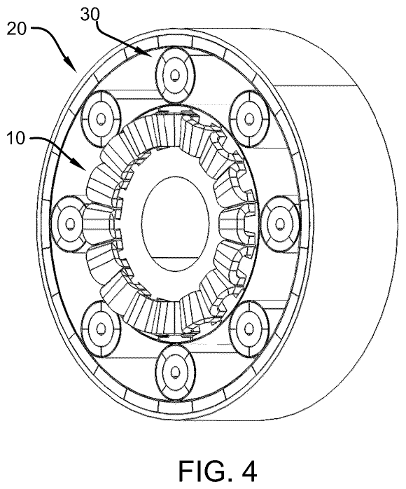

It should be noted that the scope of the present innovation is not limited to the example described herein. Multiple configurations of the device 1 are possible, including variations in the number of rollers 30 and stator teeth 15, as well as alternative rotor 20 arrangements such as an outer rotor configuration shown in FIG. 4. In this configuration the stator 10 is positioned inside the rotor 20 with the rollers 30 placed between the stator 10 and rotor 20.

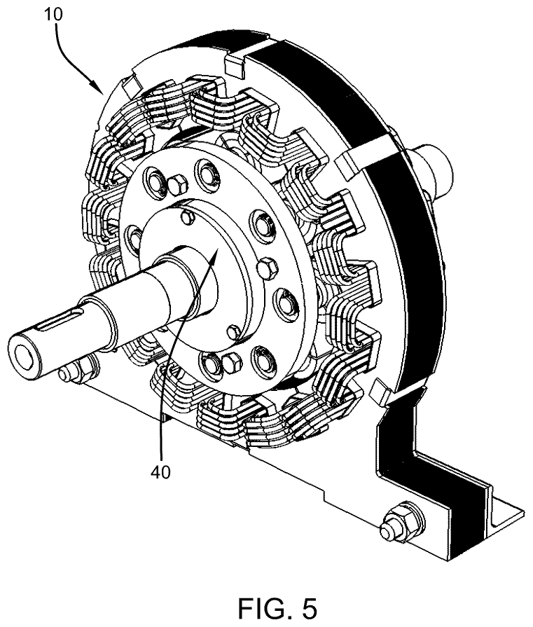

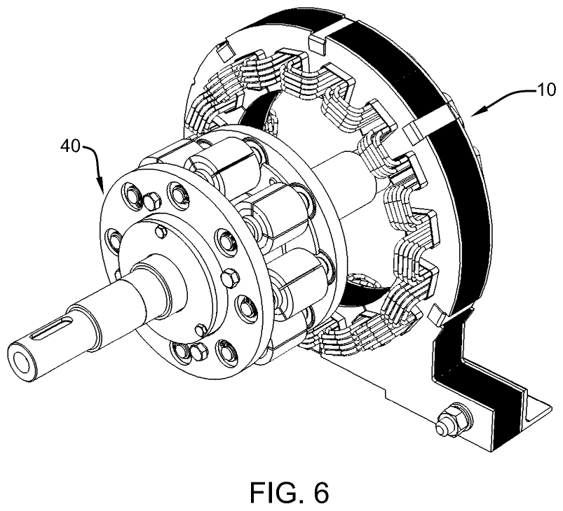

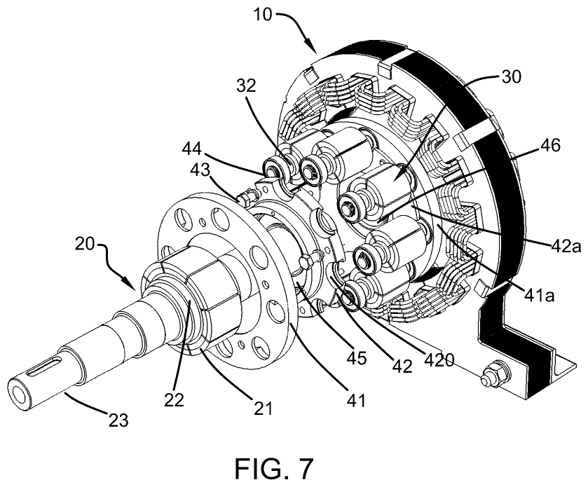

The rollers 30 must be secured at equal distances from each other to ensure proper device 1 operation. Therefore, additional components need to be incorporated into the device 1 design. FIG. 5 illustrates the complete assembly of the device 1 demonstrating the integrated planetary mechanism 40 inside the stator 10. The integrated planetary mechanism 40 is shown separately from the stator 10 in FIG. 6. An exploded view of the planetary mechanism 40 separated from the stator 10 is provided in FIG. 7. The magnetic rollers 30 are secured to retaining rings 41 and 41a located on both sides of the planetary mechanism 40, thereby preventing collisions and maintaining alignment. In alternative embodiments, the retaining ring 41 may be substituted with a retaining star or other configuration, which provides increased open space between rollers 30 to enhance cooling. Also, the rotor shaft 23 can be directly connected to the retaining rings 41 and 41a for low-speed applications. In this case, the rotor core 22 and rotor magnets 21 can be eliminated from the design.

In some embodiments, the retaining rings 41 incorporate roller brackets 42 and 42a with circular grooves 420 to establish the vertical position of the rollers 30 relative to the rotor core 22 and prevent interference during assembly. In some embodiments, the brackets 42 are secured to the retaining rings with bolts 43. The rollers are attached to the retaining rings 41 and 41a by inserting the shafts 32 into the ball bearings 44, which are press-fitted into the retaining rings 41 and 41a.

Finally, because the rotor assembly 20 and the roller retaining rings 41 and 41a rotate at different speeds, the retaining ring 41 and the rotor 20 may be mounted on separate bearing sets 45,46. In some embodiments, all the ball bearing sets 44, 45, 46 in the device 1 may be replaced with friction bearings, providing a practical solution for lightweight, short-life motors such as those used in torpedoes or expendable drones.

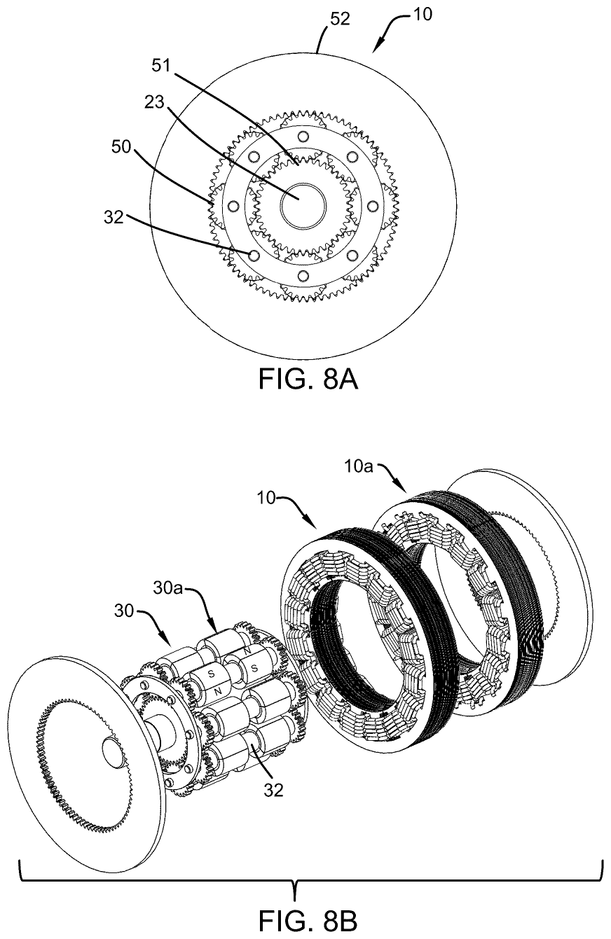

The magnetic coupling between the rollers 30 and the rotor 20 may alternatively be replaced by a mechanical transmission depicted in FIG. 8A and FIG. 8B. In this configuration, planetary gears 50 are mounted on the roller shafts 32; the sun gear 51 is affixed to the rotor shaft 23; and the ring gear 52 is attached to the stator 10 as illustrated in FIG. 8A. The electromagnetic torque generated by the stator 10 and applied to the rollers 30 is now mechanically transmitted to the rotor shaft 23 through the planetary gears 50 and sun gear 51 similar to a conventional mechanical planetary gearbox. While this configuration introduces mechanical losses attributable to friction, it provides the significant advantage of eliminating the requirement to match the roller 30 pole pitch length with the rotor 20 pole pitch length. Consequently, a broader range of roller-to-stator radius ratios may be employed.

Furthermore, the mechanical transmission described in this embodiment can obviate the need for conventional ball bearings, as the rollers 30 and rotor 20 are now vertically retained by the gear assembly 50. To prevent axial displacement of the rotor 20 and rollers 30 within the stator core 10, conical gears may be utilized.

To reduce cogging forces between the rollers 30 and the stator 10, as well as between the rollers 30 and the rotor 20, the device 1 may be configured in two sections offset relative to each other, as illustrated in FIG. 8B. The stators 10 and 10a are displaced by one and a half stator tooth 15 pitches, while the rollers 30 and 30a are offset by half of their pole pitch. This arrangement cancels cogging torques in corresponding sections, enabling closer placement of rollers 30. The offset configuration promotes smooth rotation of the rotor 20, with minimized acoustic noise, and more uniform torque output.

In embodiments incorporating planetary mechanical coupling, the space between the stator 10 sections may accommodate cooling fans mounted on the roller shafts 32. This feature provides an effective means of internal cooling, particularly for the end windings of both stator 10 sections, thereby improving thermal management and overall motor performance.

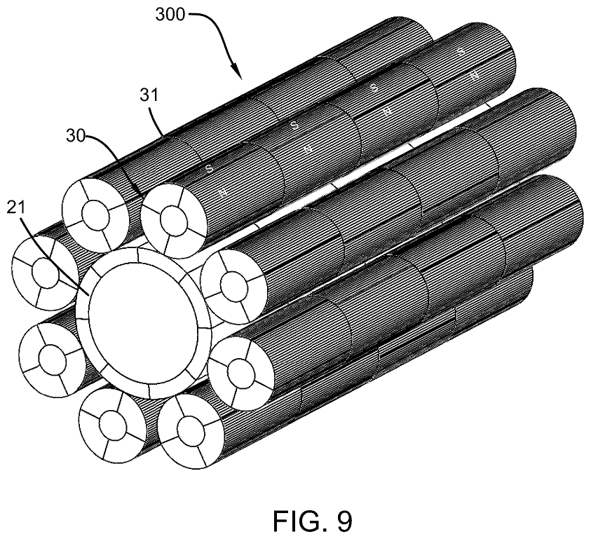

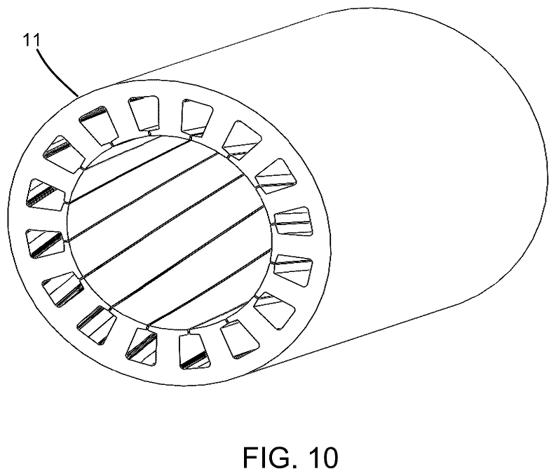

Smooth torque generation can also be achieved with a single stator 10, by skewing the roller magnets 31, stator teeth 15, winding 12, and rotor magnets 21 for a selected angle. FIG. 9 depicts a skew on the roller magnets 31 by a corresponding skew angle. The same skew is applied to the rotor magnets 21. FIG. 10 demonstrates a skew of the stator teeth 15 on the stator core 11 matching the skew angle of the rollers 30. The depicted in FIG. 10 motor winding 12 is then skewed accordingly so that its orientation aligns with the skewed magnets 31 on the rollers 30 (FIG. 9) and skewed stator teeth 15 (as seen in FIG. 10).

Importantly, this skew does not substantially reduce the device 1 torque that occurs in conventional electric machines. In conventional designs, either the rotor or the stator is skewed to mitigate cogging effects, which inherently reduces torque because portions of the torque vector cancel out. In the device 1, however, the stator 10 skew corresponds to the roller 30 skew, thereby preserving torque-producing alignment. As a result, torque remains substantially unaffected while cogging forces between the rollers 30, between the rollers 30 and the stator 10, and between the rollers 30 and the rotor 20 are effectively minimized.

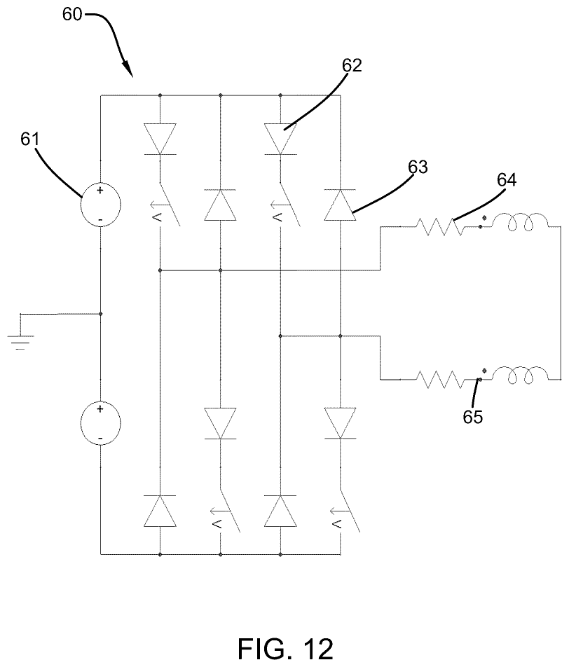

FIG. 12 represents a two-phase electric circuit 60 for supplying the device 1 with electric power. Assembled with a direct current power supply or battery 61, a plurality of electronic switches 62 and diodes 63, the voltage from the power supply 61 is delivered to two motor phases which are: phase A 64, and phase B 65. Controlling the electronic switches 62 allows supplying the motor phases 64 and 65 with two sinusoidal voltages shifted apart by ninety electrical degrees.

Although the provided example of the device 1 is a two-phase rotary electric motor, the invention is applicable to other single and multi-phase configurations of electric machines, including linear actuators, generators, and machines providing two degrees of mechanical freedom. In addition, the invention described in this embodiment can be implemented in an axial- and transverse-flux electric machine arrangement.

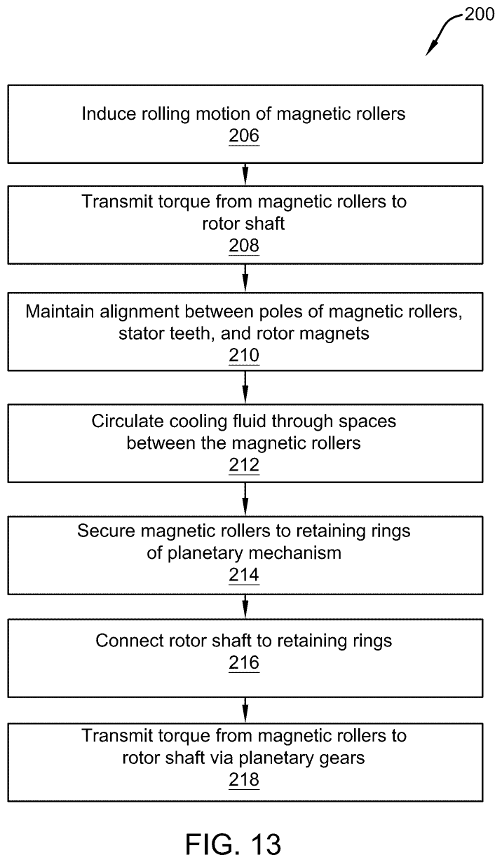

The present invention is also comprised of a method of using 200 the device 1, as seen in FIG. 13. First, a device 1 is provided comprised of a stator assembly 10 including a stator core 11, stator windings 12, and stator teeth 15, a rotor assembly 20 including a rotor core 22, rotor magnets 21, and rotor shaft 23, and a roller ring 300 comprising a plurality of magnetic rollers 30, each including roller magnets 31 and roller shaft 32 [Step 202]. Then, the stator windings 12 can be energized to produce a traveling magnetic field across the stator teeth 15 [Step 204]. Next, the traveling magnetic field can induce rolling motion of the magnetic rollers 30 within the roller ring 300, positioned between the stator assembly 10 and the rotor assembly 20 [Step 206]. Then, torque can be transmitted from the rollers 30 to the rotor shaft 23 by magnetic interaction with the rotor magnets 21, causing rotation of the rotor assembly 20 in the direction opposite to that of the roller rotation [Step 208]. Next, alignment between the poles of the rollers 30, the stator teeth 15, and the rotor magnets 21 can be maintained by matching the roller pole pitch, the stator tooth pitch, and the rotor pole pitch [Step 210]. As a result, synchronous operation of the device 1 can be achieved with a rotor speed determined by the voltage frequency supplied to the stator windings 12. In one embodiment, cooling fluid can be circulated through spaces between the rollers 30 to provide internal thermal management and enhance heat dissipation during operation [Step 212]. Then, the rollers 30 can be secured by retaining rings 41,41a of a planetary mechanism 40 to prevent collision and maintain equidistant spacing and alignment within the device 1 [Step 214] Next, the rotor shaft 23 can be connected directly to the retaining rings 41,41a for low-speed applications, allowing removal of the rotor core 22 and magnets 21 when magnetic coupling is not required [Step 216]. Finally, torque from the rollers 30 can be transmitted mechanically to the rotor shaft 23 via planetary gears 50, wherein sun gear 51 is mounted to the rotor shaft 23 and ring gear 52 is attached to the stator assembly 10, thereby enabling positional stability of the rollers 30 and rotor 20 without the use of ball bearings [Step 218].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gapless rolling motor device” and “device” are interchangeable and refer to the gapless rolling motor device 1 of the present invention.

Notwithstanding the foregoing, the gapless rolling motor device 1 of the present invention and its various components can be of any suitable size and configuration as is known in the art without affecting the overall concept of the invention, provided that they accomplish the above-stated objectives. One of ordinary skill in the art will appreciate that the size, configuration, and material of the gapless rolling motor device 1 as shown in the FIGS. are for illustrative purposes only, and that many other sizes and shapes of the gapless rolling motor device 1 are well within the scope of the present disclosure. Although the dimensions of the gapless rolling motor device 1 are important design parameters for user convenience, the gapless rolling motor device 1 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gapless rolling motor device comprising:
a stator comprised of a stator tooth and a stator winding;
a rotor positioned concentrically with the stator;
a plurality of magnetic rollers arranged in a ring and disposed between the stator and the rotor;
wherein a magnetic roller of the plurality of magnetic rollers is comprised of a plurality of permanent magnets disposed on a roller shaft;
wherein the stator winding is configured to generate a rotating magnetic field that causes the plurality of magnetic rollers to roll along a surface of the stator while orbiting the rotor; and
a magnetic coupling positioned between the plurality of magnetic rollers and the rotor, wherein the magnetic coupling transmits torque to the rotor to produce a rotation of the rotor.

2. The gapless rolling motor device of claim 1, wherein the stator winding is comprised of a two-phase winding that produces a first sinusoidal voltage and a second sinusoidal voltage offset by ninety electrical degrees to form a traveling magnetic field.

3. The gapless rolling motor device of claim 1, wherein the plurality of magnetic rollers are uniformly distributed along an inner circumference of the stator and are constrained by a plurality of retaining rings disposed on a plurality of opposite axial sides of the plurality of magnetic rollers.

4. The gapless rolling motor device of claim 1, wherein the plurality of permanent magnets are surface-mounted on or embedded within a rotor core of the rotor.

5. The gapless rolling motor device of claim 1, wherein a space between the plurality of magnetic rollers permits an internal airflow through the gapless rolling motor device for cooling.

6. The gapless rolling motor device of claim 1 further comprised of a roller ring and wherein the roller ring is mounted on a first bearing set to accommodate a first rotational speed and the rotor is mounted on a second bearing set to accommodate a second rotational speed.

7. The gapless rolling motor device of claim 6, wherein the gapless rolling motor device is configured as a motor, a generator, a linear actuator, or a machine providing two degrees of mechanical freedom.

8. The gapless rolling motor device of claim 1, wherein the rotor is comprised of a plurality of skewed permanent magnets.

9. The gapless rolling motor device of claim 8, wherein the plurality of permanent magnets disposed on the roller shaft are skewed, and wherein a stator core of the stator and the stator winding are skewed by a corresponding angle to the plurality of skewed permanent magnets and the plurality of permanent magnets disposed on the roller shaft.

10. The gapless rolling motor device of claim 1 further comprised of a second stator that is angularly offset relative to the stator, wherein the plurality of magnetic rollers are offset by a fraction of a pole pitch of the plurality of magnetic rollers.

11. A gapless rolling motor device comprising:
a stator comprised of a stator tooth;
a rotor comprised of a rotor shaft;
a plurality of magnetic rollers arranged in a ring and disposed between the stator and the rotor;
wherein a magnetic roller of the plurality of magnetic rollers is comprised of a roller shaft;
a planetary gear transmission comprised of a plurality of planetary gears attached to the roller shaft;
a sun gear disposed on the rotor shaft;
a ring gear attached to the stator;
wherein an electromagnetic torque generated by the stator is applied to the plurality of magnetic rollers and is mechanically transmitted to the rotor shaft through the planetary gear transmission; and
wherein the planetary gear transmission provides an axial positional stability and a radial positional stability of the rotor and the plurality of magnetic rollers.

12. The gapless rolling motor device of claim 11 further comprised of a second stator.

13. The gapless rolling motor device of claim 12, wherein the second stator is angularly offset relative to the stator.

14. The gapless rolling motor device of claim 13, wherein the angular offset is comprised of one and one-half pitches of the stator tooth.

15. The gapless rolling motor device of claim 13, wherein the plurality of magnetic rollers are offset by one-half of a pole pitch of a magnetic roller.

16. The gapless rolling motor device of claim 11, wherein the planetary gear transmission is in the form of a conical gear.

17. A method of using a gapless rolling motor device, the method comprising:
providing a gapless rolling motor device comprised of a stator assembly comprised of a stator core, a stator winding, and a stator tooth, a retaining ring comprised of a bracket, a rotor assembly comprised of a rotor core, a rotor magnet, and a rotor shaft, and a roller ring comprising a plurality of magnetic rollers comprised of a plurality of roller magnets and a plurality of roller shafts;
energizing the stator winding to produce a rotating magnetic field;
inducing a rolling motion of the plurality of magnetic rollers such that the plurality of magnetic rollers orbit the rotor while rolling along the stator; and
magnetically transmitting a torque from the plurality of magnetic rollers to the rotor to cause rotation of the rotor.

18. The gapless rolling motor device of claim 17, wherein the gapless rolling motor device operates synchronously with a speed determined by a voltage frequency of the stator.

19. The gapless rolling motor device of claim 17 further comprised of securing the plurality of magnetic rollers to the bracket of the retaining ring.

20. The gapless rolling motor device of claim 17, wherein the torque is transmitted to the rotor through a planetary gear mechanism disposed on the plurality of roller shafts and a sun gear disposed on the rotor shaft.
